(19) United States
(12) Patent Application Publication
(10) Pub. No.: US 2006/0013551 A1
(43) Pub. Date: Jan. 19, 2006

(54) Symmetrization structures for process-tolerant integrated optical components

(76) Inventors: James S. Foresi, Albuquerque, NM (US); Tairan Wang, Chelmsford, MA (US); Jean-Francois Viens, Boston, MA (US); Dale Fried, Dedham, MA (US); Mohammad Jalal Khan, Woburn, MA (US); Michael Lim, Cambridge, MA (US); Anuradha Agarwal, Weston, MA (US); Gokhan Ulu, Roslindale, MA (US)

Correspondence Address: Matthew E. Connors;Gauthier & Connors LLP, Suite 2300, 225 Franklin Street, Boston, MA, 02110, US

(21) Appl. No.: 11/146,968

(22) Filed: Jun. 7, 2005

Related U.S. Application Data
(60) Provisional application No. 60/577,954, filed on Jun. 8, 2004.

(51) Int. Cl. G02B 6/10

(52) U.S. Cl. 385/129

(57) ABSTRACT

An integrated planar waveguide system including at least two primary waveguides for light propagation and coupling, and two or more mirror-imaged symmetrization structures in close proximity to the primary waveguides in order to provide micro-process-equalization during etch, growth, annealing and reflow processes. The primary waveguides are designed to carry light signals. The symmetrization waveguide structures are designed so that all the trenches between primary waveguides are identical to the desired degree. At the same time, the symmetrization structures are designed to have minimal detrimental impact on the optical performance of the coupler.

### PRIORITY INFORMATION

This application claims priority to provisional application Ser. No. 60/577,954 filed Jun. 8, 2004, incorporated herein by reference in its entirety.

### BACKGROUND OF THE INVENTION

The performance of integrated optical components can be altered by local variations of manufacturing processes such as etching, deposition, annealing or reflow. Additionally, other parameters, such as stress or thermal gradients, can cause degradation in the performance of integrated optical components if they vary due to component placement. The effects of the local variations impact performance of devices in various ways depending on the cross-sectional geometry of the optical waveguides. In optical waveguides, it has been found that asymmetries in cross-sectional geometry, such as tilted sidewalls or index gradients, can produce unwanted cross-polarization coupling, i.e. coupling between different electric field polarizations. Such effect can significantly limit the performance of integrated optical components based on waveguides, such as directional couplers and Mach Zehnder interferometers (MZIs).

In integrated optics, directional couplers are fundamental building blocks. A directional coupler is used to split signals or to transfer signals from one waveguide to another. The directional coupler functions by bringing waveguides into close proximity in order to allow their respective modal fields to overlap. The overlap and the phase relation between the incident light and coupled light allow light transfer from one waveguide to the other. Directional couplers are often used in conjunction with other optical components such as gratings and, in certain light-path architectures, in conjunction with MZIs.

The performance of the directional couplers directly impacts the performance of the composite device. For several applications including optical communication systems, one of the key performance measures is that directional couplers should be polarization insensitive. In particular, the two primary polarizations of the nominal waveguide should not interact with each other. As a proto-typical example of a coupler-based device, a coupler with a length such that the incoming light from one waveguide can be completely transferred to the other waveguide is considered. The amount of light that remains in the original waveguide can then be used as a measure of the coupler performance.

In planar waveguide systems, to reduce device size, directional couplers tend to have waveguide separations on the same order as the waveguide width and waveguide height. This leads to different environments for the region between the two waveguides of the coupler and the regions outside the coupler, for both the etching process which defines the waveguide, and the deposition process of the upper cladding. The effect of any asymmetry to the waveguide from any of the above mentioned sources during the fabrication process is to induce a slight coupling between the two primary polarizations of the nominal waveguide. For a 100%-coupler, this translates into the inability to transfer light completely from one waveguide to the other.

In other devices, such as variable optical attenuators or MZI devices, the phase difference between the two arms in the structure can affect the performance of the device. If the two arms do not experience the same local environment during processing, the performance will be affected. In the case of an equal-arm-length Mach Zehnder device composed of two 3 dB couplers separated by straight uncoupled waveguide sections, the composite device should behave as a 100% coupler. However, if the two arms are not exactly the same, the performance of the composite coupler will be compromised. The arms can be made unequal due to a variety of process non-uniformities, such as waveguide thickness, width, sidewall angle or index variations. However, performance can also be compromised as a result of local process variations when the environment for each arm is not equivalent. For example, if one of the arms is within approximately 10 coupling lengths of another structure while the other has no nearby structures, this can cause difference in arm performance.

### SUMMARY OF THE INVENTION

This invention relates to symmetrization structures placed in close proximity to primary integrated optical waveguides in order to reduce, or eliminate, the problems of local variations of etching, deposition, annealing or reflow during the fabrication of integrated optical waveguide devices.

In one embodiment, the design for a directional-coupler system includes two optically coupled primary waveguides, which carry light signals and are potentially connected to other devices, and two or more symmetrization structures on the outside of each of the primary waveguides. The pattern for the symmetrization structures is designed to provide substantially the same process environments for the inner sidewalls of the two primary waveguides and the outer sidewalls of the primary waveguides. Once the lithography and etching are complete, the symmetrization structures provide substantially the same environment for follow-up re-growth steps. The symmetrization structures are also designed to have minimal impact on the optical performance of the coupler system.

In another embodiment, the symmetrization structures are etched away in a second etch step. When most of the asymmetry occurs during the etching of the primary waveguide, this approach eliminates most of the asymmetry by providing the same etch environment to the inner and outer sidewalls of the primary waveguide during the etching. The symmetrization structures are subsequently removed so that they do not have any optical performance impact on the coupler system.

In yet another embodiment of the invention, symmetrization structures are used to control the effects of local process variation on structures that are not optically coupled. For example, if an array of equal arm-length MZIs are included on a single integrated chip and the individual components are equally spaced, all of the interior MZIs will experience identical, symmetric local environments. The MZIs on the two ends of the arrays, however, will have asymmetric environments-one arm of each MZI will have an adjacent MZI structure, while the other will have a field devoid of additional elements. The imbalanced local environment for the outer MZIs will imbalance their arms causing the extinction ratio between the two outputs of the device to deteriorate. To eliminate this imbalance, an additional structure, which consists of an unused MZI, is added to either side of the array. This structure enforces symmetry for the local environment of all of the devices on the integrated chip. As in the case of the directional coupler embodiment, if the local variations are primarily associated with the etch step, the unused MZI structures can be removed by a subsequent etch step.

The above and other features of the invention including various novel details of construction and combinations of parts, and other advantages, will now be more particularly described with reference to the accompanying drawings. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

FIG. 1 is a plan view of a typical directional coupler in a planar waveguide system, showing the line of mirror symmetry of the device;

FIG. 2 is a cross-sectional view of a typical directional coupler, with etch and overgrowth induced waveguide refractive index asymmetry;

FIG. 3 is a plot showing the responses of a typical directional coupler with etch and overgrowth induced waveguide refractive index asymmetry;

FIG. 4 is a cross-sectional view of the improved directional coupler, showing the symmetrization structures on the outside of the primary waveguides;

FIG. 5 is a plan view of the improved directional coupler, showing the symmetrization structures on the outside of the primary waveguides;

FIG. 6 is a plot showing the responses of a directional coupler with symmetrization structures;

FIG. 7 is a graph showing the optical loss (b/a)² induced by the symmetrization structures as function of the width wq of the symmetrization structure, for two primary waveguides forming a 100% directional coupler;

FIG. 8 is a plan view of a directional coupler with asynchronous symmetrization structures terminated in tight radius spirals;

FIG. 9 is a plan view of an equal-arm-length MZI structure with directional couplers employing asynchronous symmetrization structures as shown in FIG. 6;

FIG. 10 is an array of equal-arm-length MZI structures. The top- and bottom-most MZI structures in the array are not active, but are included to symmetrize the process;

FIG. 11 is an array of equal-arm-length MZI structures where symmetrization structures have been included between the MZIs to symmetrize the process.

### DETAILED DESCRIPTION OF THE INVENTION

The invention relates to symmetrization structures placed in close proximity to primary integrated optical waveguides in order to reduce, or eliminate, the problems of local variations of etching, deposition, annealing or reflow during the fabrication of integrated optical waveguide devices.

In particular, this invention relates to symmetrization structures placed in close proximity to primary optical waveguides in order to improve the cross-sectional symmetry of the primary optical waveguides during the various fabrication steps. The primary optical waveguides share a common line of symmetry and can be optically coupled or not.

The proximal symmetrization structures can be used more generally to improve the cross-sectional symmetry of primary optical waveguides used in a variety of integrated optical devices such as directional couplers and Mach Zehnder interferometers, in order to improve their polarization properties without inducing detrimental optical losses.

“Primary integrated optical waveguides” refer to waveguide structures that carry an optical signal and perform optical signal processing such as routing and multiplexing. “Symmetrization structures” refer to waveguide structures placed in close proximity to the primary integrated optical waveguides, but do not carry any useful optical signal nor perform signal processing, their purpose being process-related. “Etching” refers to the controlled fabrication step of removing integrated circuit material on a substrate, within controlled chemical, thermal and pressure environments inside a plasma chamber. “Deposition” refers to the controlled fabrication step of adding new integrated circuit material on a substrate. “Annealing” refers to the controlled fabrication step of thermally activated material stress relaxation or diffusion. “Reflow” refers to the controlled fabrication step of material regrowth, viscoelastic flow or consolidation on a profiled substrate. “Close proximity” refers to the typical spatial extent of local process variations (pressure, chemical, thermal gradients inside plasma chamber), typically in the range 0 to 100 microns. All the said controlled fabrication steps are subject to unwanted local non-uniformities across the substrate, such as local variations of pressure or local variations of chemical/thermal loading, creating unwanted local asymmetries in the fabricated optical waveguides and devices. The purpose of the symmetrization structures is to reduce, or eliminate, local process variations around the primary optical waveguides in order to restore their cross-sectional symmetry.

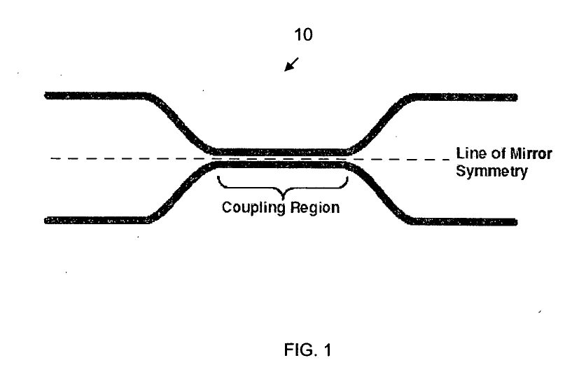

An exemplary embodiment of the invention uses directional couplers 10, as shown in FIG. 1, where any fabrication induced waveguide cross-sectional asymmetry is non-negligible due to variations of local environments across the line of mirror symmetry of the device.

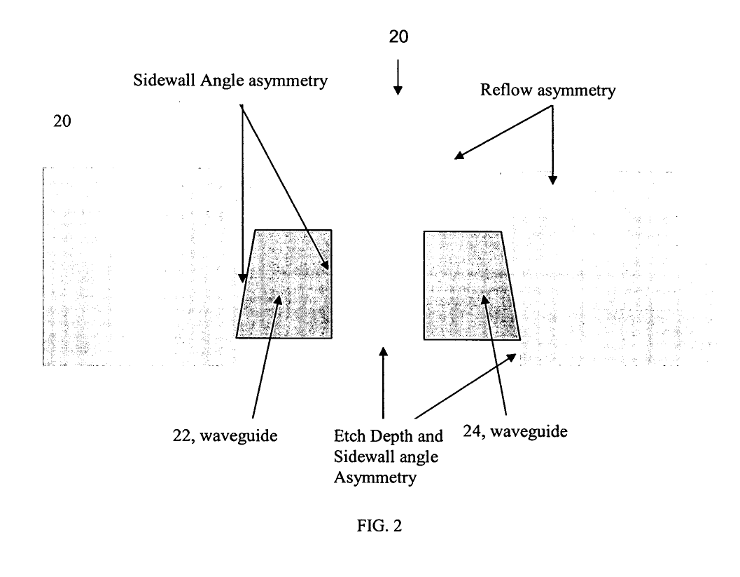

In FIG. 2, a typical cross section of the same directional coupler 20 is shown. Although the planar symmetry of the coupler guarantees that the two primary waveguides 22, 24 will be mirror images of each other, there is no guarantee that each waveguide will possess mirror symmetry individually. During processing (such as photolithography, etching, deposition, and reflow) the groove between the waveguides presents a different micro-environment than the regions outside of the two waveguides. As a result (in the case of etching for example), the sidewall angles of the inner surfaces may be different from the sidewall angles of the outer surfaces. For the deposition step of the upper cladding, the different micro-environments could induce slightly different material composition near the inner surfaces than that near the outer surfaces. These micro-environment induced differences result in a slight asymmetry to the index of refraction profile of the coupler waveguide. Impairing the mirror symmetry of each individual primary waveguide gives rise to coupling between different polarizations that can ultimately limit the light transfer capabilities of the directional coupler.

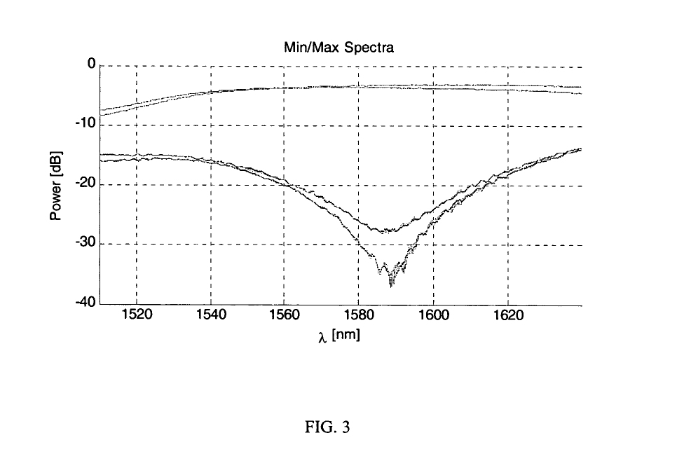

FIG. 3 shows the spectra of a directional coupler that does not possess mirror symmetry for each of the individual waveguides in the structure. The extinction is limited to approximately 25 dB and there is a large split in polarization dependent extinction.

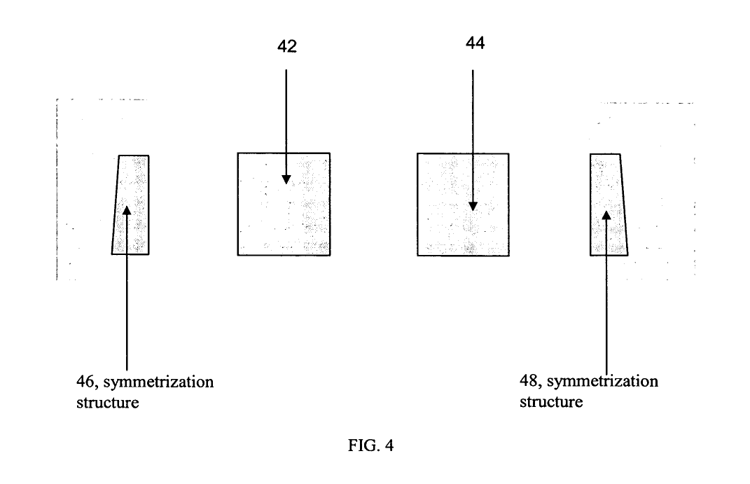

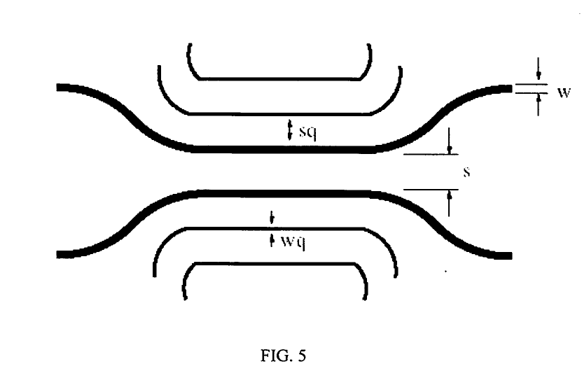

According to the invention, and as illustrated in FIG. 4, the primary waveguides 42, 44 re flanked by two symmetrization structures 46, 48, one on each side of the primary waveguides in order to maintain the original line of mirror symmetry. FIG. 5 shows a plan view of the same device with 4 symmetrization structures, as the invention can contain an even number of symmetrization structures larger than 2. The proximal symmetrization structures serve to provide substantially the same environment for the photolithography, etch, deposition and reflow of the upper cladding for the inner and outer surfaces of the primary waveguide.

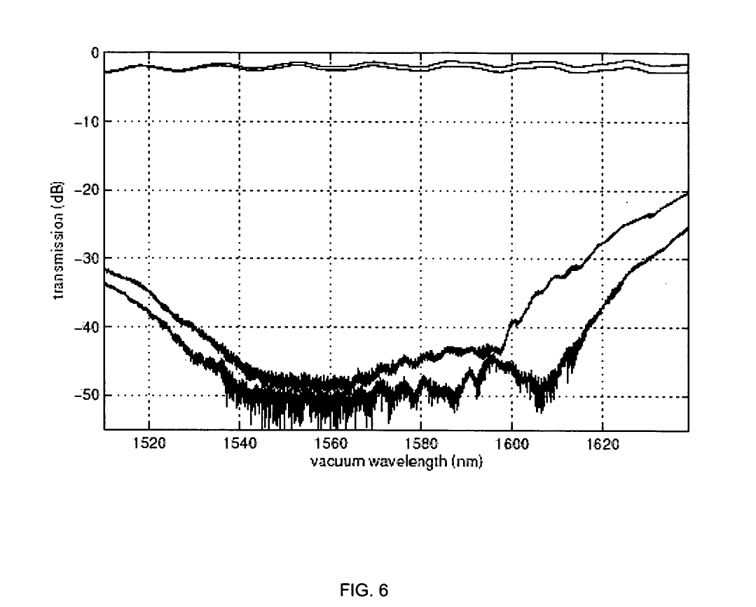

FIG. 6 shows the spectra of a directional coupler with symmetrization structures in place. The extinction for the individual polarization is seen to be greater than −45 dB as opposed to −25 dB without symmetrization structures.

In order to design a symmetrization structure for a directional coupler that can be left in place without degrading the performance of the coupler, it is necessary to design the structure while taking into account optical coupling into the symmetrization structures. The approach described here relies on optical phase mismatch to limit the transfer of light from the primary waveguides to the symmetrization structure.

The optical coupling per unit length, μ, between any two guiding structures depends on the waveguide parameters, such as the guided wavelength λ, the waveguide geometries, and the waveguide separations. Waveguides are also characterized by a propagation constant, β, where β=2πN/λ, and where N is the effective refractive index of the waveguide. A phase mismatch, Δβ, between two waveguides can be obtained by creating a difference between the propagation constants, such that Δβ=βₐ−β_{β} is not zero, where βₐ and β_{b} represent the different propagation constants of two given coupled waveguides. The transfer between any two coupled waveguides can be described by the well-known coupled-mode equations:

$$\frac{ⅆ}{ⅆ z} ( \begin{matrix}{a}_{TE} \\ {b}_{TE} \\ {a}_{TM} \\ {b}_{TM}\end{matrix} ) = ( \begin{matrix}- ⅈ {β}_{TE} & - ⅈ {μ}_{TE} & - ⅈ α Δ β & 0 \\ - ⅈ {μ}_{TE} & - ⅈ {β}_{TE} & 0 & + ⅈ α Δ β \\ - ⅈ α Δ β & 0 & - ⅈ {β}_{TM} & - ⅈ {μ}_{TM} \\ 0 & + ⅈ α Δ β & - ⅈ {μ}_{TM} & - ⅈ {β}_{TM}\end{matrix} ) ( \begin{matrix}{a}_{TE} \\ {b}_{TE} \\ {a}_{TM} \\ {b}_{TM}\end{matrix} )$$

This equation describes the electromagnetic field transfer evolution, along the length z of the waveguides, between the modes a_{TE}, a_{TM}, b_{TE}, and b_{TM} of the coupled waveguides, with propagation constants β_{TE}, β_{TM}, and mutual coupling strengths μ_{TE}, μ_{TM}, and including a polarization mode admixture (cross-polarization mixing) coefficient α between the TE and TM modes of the same waveguide. In the case of a directional coupler made of two coupled waveguide modes, a_{TE} and b_{TE}, and a_{TM} and b_{TM}, without mode admixture, the transferred intensity between the two waveguides can be described as:
(b_{TE}/a_{TE})²=[1+(Δβ_{TE}/μ_{TE})²]⁻¹ sin² {μ_{TE} L [1+(Δβ_{TE}/μ_{TE})²]^{1/2}},
(b_{TM}/a_{TM})²=[1+(Δβ_{TM}/μ_{TM})²]⁻¹ sin² {μ_{TM} L [1+(Δβ_{TM}/μ_{TM})²]^{1/2}},
where Δβ_{TE}=β_{aTE}−β_{bTE} represents the phase mismatch in TE polarization between the two coupled waveguides, Δβ_{TM}=β_{aTM}−β_{bTM} represents the phase mismatch in TM polarization between the two coupled waveguides, μ_{TE} and μ_{TM} represent coupling strengths in TE and TM polarizations, and L represents the coupling length of the directional coupler. By inspection it can be deduced from this equation that, for a given directional coupler length L, the electromagnetic field transfers (b_{TE}/a_{TE})² and (b_{TM}/a_{TM})² from one waveguide to the other are minimized by maximizing the phase mismatches Δβ_{TE} and Δβ_{TM} and by minimizing the coupling strengths μ_{TE} and μ_{TM}. A phase mismatch Δβ (either TE or TM) can be obtained with waveguides of different geometries, such as, but not limited to, different widths, different heights, different shapes, different indices, etc. A directional coupler with non-zero Δβ is often referred to as an asynchronous coupler, i.e. a coupler with non-zero optical phase mismatch. The coupling strength μ (either TE or TM) between the waveguides can be adjusted by changing the different waveguide properties such as, but not limited to, waveguide separation, waveguide geometries, and waveguide indices.

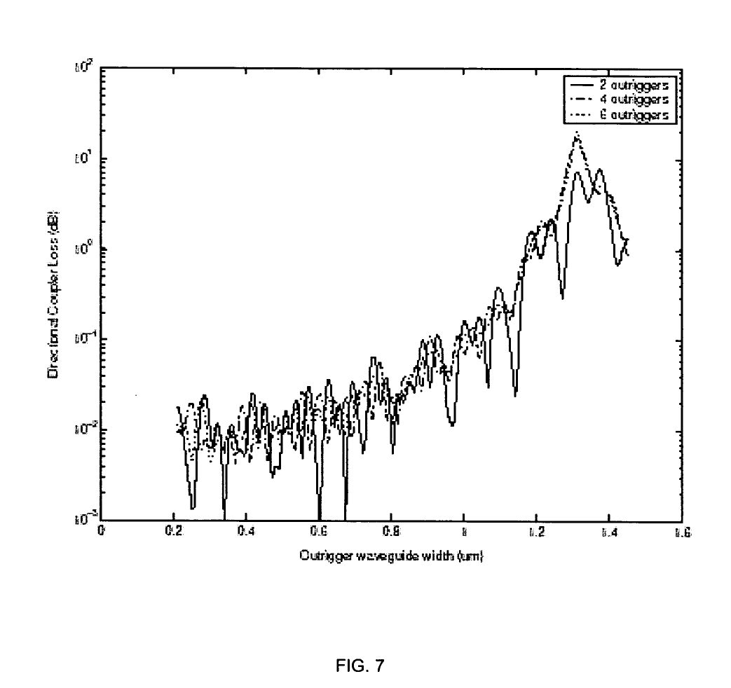

By designing properly the directional coupler geometries, it is possible to achieve a ratio of Δβ/μ>10 with narrow symmetrization waveguide structures, such that the power transfer (b/a)² is less than 1%, or equivalently, less than 0.05 dB, as shown in FIG. 7. Therefore, an asynchronous coupler with narrow waveguides can be used as a low-loss symmetrization structure.

A mode admixture coefficient a arises when the individual primary waveguides have cross-sectional asymmetries due to process variations during fabrication. Such cross-sectional asymmetries destroy the symmetry profile of the TE and TM modes carried by the waveguides, and induce unwanted polarization-dependent power transfer between the waveguides, which reduces the optical performance of the coupler device. Restoration of cross-sectional symmetry via symmetrization structures is necessary for most integrated optic applications.

An exemplary embodiment of the invention is a symmetrization structure made of narrow waveguides in close proximity to the primary optical waveguides as shown on FIG. 5. Such a narrow symmetrization structure ensures a large Δβ/μ ratio, therefore low loss. Also, the restored symmetry of the primary waveguides ensures that the polarization mode admixture coefficient a is very small, therefore ensures low polarization mixing and restores symmetry of the TE and TM polarized modes carried by the primary waveguides.

Although the power transfer into the symmetrization structures is small by design, the symmetrization structures support TE and TM modes of their own, with mirror-image profile symmetry.

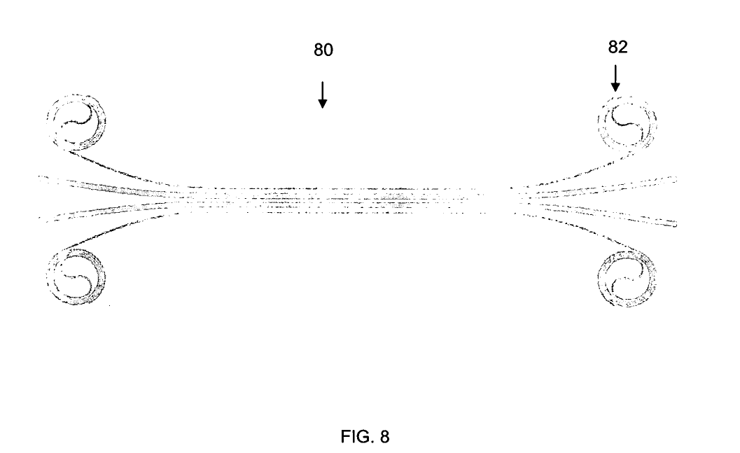

If an asynchronous coupler is used as a symmetrization structure, there is still a finite amount of light that will be coupled into it. As a result, it is necessary to terminate the structure appropriately in order to avoid back reflections. In FIG. 8, a symmetrization structure 80 terminated with a small radius spiral 82 is shown. The small radius results in coupling of the light into radiation modes outside of the waveguide. The termination structures used are preferably designed as to be symmetric with respect to the directional coupler and to be far enough away from the coupler to limit the effects on the asymmetry induced by the structures on the coupler performance.

Although the embodiment described here includes two symmetrization structures, the approach can be broadened to a greater number of structures, such as 4, 6, 8 or higher even number of symmetrization structures, designed to control the local-process variations while minimizing the deleterious effects on performance. The symmetrization structures and primary waveguides must maintain the original line of mirror symmetry of the primary waveguides and restore cross-sectional symmetry for each primary waveguides during fabrication. The distance which separates the symmetrization structures from the primary waveguides need not be identical to the distance between the primary waveguides in order to limit the unwanted effects of local process variations.

If the etching step is the primary source of asymmetry, then once the etching step is completed, the primary waveguides of the coupler will have been symmetrized. A second etch step can then be undertaken to remove the symmetrization structures. In this case, it is not necessary to design the symmetrization structures to control their affects on optical performance.

Any width of equalization structure could be used since optical coupling to this structure could not occur after the removal of the structure.

If the deposition, annealing or reflow steps are the primary sources of asymmetry, the same symmetrization structures can be used to correct for cross-sectional asymmetry of the primary waveguides.

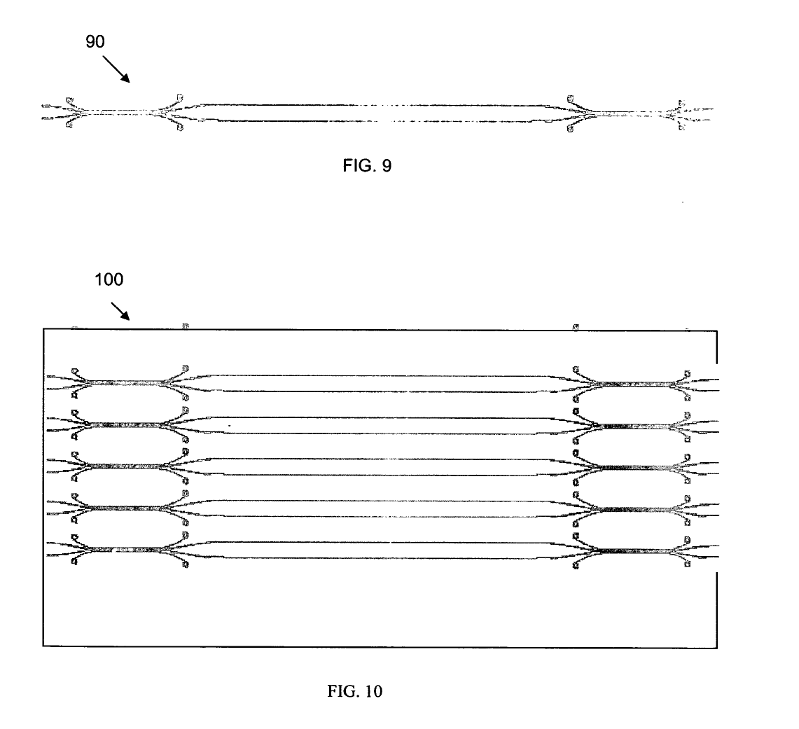

In another embodiment of the invention, symmetrization structures are used to eliminate unwanted process variations from structures that are not optically coupled, such as an equal-arm-length MZI 90, as shown in FIG. 9. The MZI consists of a 3 dB coupler which feeds to individual arms of identical design followed by an additional 3 dB coupler which recombines the signals after they travel through the arms. Light input into the structure will exit through the bar port or the cross port, depending on the phase difference between the two arms. The amount of light present at the bar port output (Pₒᵤₜ), in the case where the input and output directional couplers are 50/50 couplers, is described by:
Pₒᵤₜ=P[1−cos(φ₁−φ₂)]
where P is the intensity of the light in the two arms of the MZI and φ₁ and φ₂ are the phase delays in each of the two arms. If the phase delays are identical, none of the light will arrive at the output port. If the phase delays are not identical, due to local process variations, light will leak into the output port and can result in crosstalk or poor extinction ratios for integrated optical devices. Lack of symmetrization for the two arms can result in phase delay differences and polarization mixing. These differences can be caused by process induced asymmetries such as local variations of etching, deposition, annealing or reflow, or stress asymmetries due the asymmetric placement of devices, or asymmetries due to control structures that may be above the devices.

In order to eliminate the unwanted process variations, symmetrization structures in close proximity to individual waveguide arms of the MZI must be included. In the MZI array structure 100 shown in FIG. 10, additional MZIs that are not used are included to ensure that the local environments for the arms of all of the devices are identical. The additional MZIs can include only the waveguide pattern, or can extend to include control elements such as heaters or electrical contacts to ensure that all of the process and material related effects are identical for the MZI arms.

An exemplary embodiment of the invention is a Mach Zehnder device or a variable attenuator device wherein each primary waveguide is flanked by two symmetrization structures, one on either side of the primary waveguides for a total of four symmetrization structures. This embodiment can be expanded to 8, 12, 16 or higher number of symmetrization structures.

In another exemplary embodiment, we consider the two directional couplers at either end of a MZI interferometer. In some cases, it is desirable to have these couplers be as identical to each other as possible. In these cases, it is not only necessary to include structures that balance the environment on either side of the device, it is also desirable to ensure that the MZI interferometer device be symmetric from left to right.

The effects of local variation are not limited to structures in the waveguide layer of integrated optics alone. In many cases, structures above the waveguiding layer are used to control the optical components through a variety of effects, including but not limited to field effects, carrier injection, or thermo-optic effects. The structures on these layers can also affect the micro-environment of the optical devices and cause performance degradation. For example, in the case where an equal-arm-length MZI is used as a variable optical attenuator (VOA) it is common to have a structure over one arm of the device to change the phase of that arm and thus alter the amount of light at the output. However, if only one arm has a structure over it, it may cause stress variations in the arm and cause the unactivated state of the VOA from zero light at the output to some level of light leakage at the output. To counteract this effect, it is possible to include an identical structure on the unused arm to balance the effects and reinstate the symmetry of the device. This type of symmetrization can be employed in array devices, as discussed for the MZI array, as well as in individual devices as described for the VOA, as well as for primary waveguides containing a periodic corrugation along the length of the waveguides.

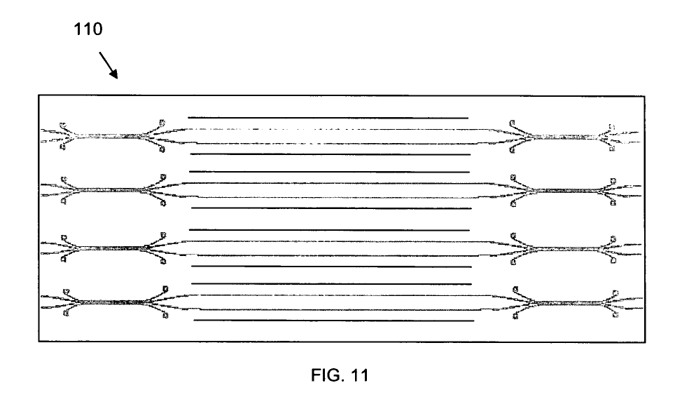

Depending on the length scale of variations, it is possible to employ symmetrization structures that do not require the full copying of existing devices. For example, in a MZI array 110, it may be possible to include a structure adjacent to each arm of the device that provides the environmental symmetrization (FIG. 11). This approach has lower impact on overall array size and allows the design of subcomponents that can be repeated across a chip without concern for larger aspects of symmetry.

Although the invention has been shown and described with respect to several exemplary embodiments thereof, various changes, omissions and additions to the form and detail thereof, may be made therein, without departing from the spirit and scope of the invention.

What is claimed is:

1. An integrated optical waveguide device comprising:
at least two primary optical waveguides and at least two symmetrization structures, wherein said primary waveguides and symmetrization structures have a mirror-image symmetry, and wherein TE and TM polarized modes carried by the said primary waveguides and symmetrization structures have a mirror-image symmetry.

2. The integrated optical waveguide device of claim 1, wherein said symmetrization structures are in close proximity to said primary waveguides and corrects for cross-sectional asymmetries of said primary waveguides arising from the etching process.

3. The integrated optical waveguide device of claim 1, wherein said symmetrization structures are in close proximity to said primary waveguides and corrects for cross-sectional asymmetries of said primary waveguides arising from the deposition process.

4. The integrated optical waveguide device of claim 1, wherein said symmetrization structures are in close proximity to said primary waveguides and corrects for cross-sectional asymmetries of said primary waveguides arising from the annealing process.

5. The integrated optical waveguide device of claim 1, wherein said symmetrization structures are in close proximity to said primary waveguides and corrects for cross-sectional asymmetries of said primary waveguides arising from the reflow process.

6. The integrated optical waveguide device of claim 1, wherein said primary waveguides form a directional coupler device.

7. The integrated optical waveguide device of claim 1, wherein said primary waveguides form a Mach Zehnder interferometer (MZI) device.

8. The integrated optical waveguide device of claim 1, wherein said primary waveguides form a variable optical attenuator (VOA) interferometer device.

9. The integrated optical waveguide device of claim 1, wherein said primary waveguides contain a periodic corrugation along the length of the waveguides.

10. The integrated optical waveguide device of claim 1, wherein at least one said symmetrization structure is located on each side of each said primary waveguide.

11. The integrated optical waveguide device of claim 1, wherein said primary waveguides exhibit negligible cross-polarization mixing between TE and TM modes, or negligible polarization mode admixture.

12. The integrated optical waveguide device of claim 1, wherein said symmetrization structures are terminated with small radius spirals.

13. The integrated optical waveguide device of claim 1, wherein said symmetrization structures form an asynchronous optical coupler with said primary optical waveguides.
